(19) United States
(12) Patent Application Publication
(10) Pub. No.: US 2025/0192328 A1
(43) Pub. Date: Jun. 12, 2025

(54) HOUSING PART, BATTERY HOUSING AND TRACTION BATTERY

(71) Applicant: MERCEDES-BENZ GROUP AG, Stuttgart (DE)

(72) Inventor: Thorsten HAEFNER, Nürtingen (DE)

(21) Appl. No.: 18/844,551

(22) PCT Filed: Mar. 27, 2023
(86) PCT No.: PCT/EP2023/057884

§ 371 Date: Sep. 6, 2024

(30) Foreign Application Priority Data
Mar. 29, 2022 (DE) 10 2022 001 079.8

(51) Int. Cl. H01M 50/282; H01M 50/204; H01M 50/249; H01M 50/276; H01M 50/278; H01M 50/367

(52) U.S. Cl. CPC H01M 50/282; H01M 50/204; H01M 50/249; H01M 50/276; H01M 50/278; H01M 50/367; H01M 2220/20

(57) ABSTRACT

A housing cover for a battery housing of a traction battery of an electrically operable vehicle is designed to connect to a second housing part of the battery housing. The cover has a construction of several layers with different materials, including an outer layer made of a plastic, a metal layer made of steel, and a structural layer made of a structural material. The outer layer and the metal layer are connected over a large area. The structural layer covers at least one part of a surface of the outer layer and/or the metal layer. An intermediary layer is arranged between the structural layer and the combination of outer layer and metal layer.

### BACKGROUND AND SUMMARY OF THE INVENTION

Exemplary embodiments of the invention relate to a housing part, in particular a housing cover, for a battery housing of a traction battery of a vehicle that can be operated electrically, a battery housing for a traction battery and a traction battery for a vehicle that can be operated electrically.

Housing covers or large parts of traction batteries have to be stabilized via additional connection points due to potentially disruptive oscillation behavior and endurance strength. Thus, a high degree of effort for checking to ensure the density and the corrosion requirements emerges. Additional construction space inside the battery is lost due to stiffening beads.

DE 10 2020 101 039 A1 discloses a housing cover for a battery housing of a traction battery of a motor vehicle that can be driven electrically, which serves to fit on a housing under part of the battery housing. The housing cover has a covering layer for closing, in particular for sealing, a housing interior chamber of the battery housing. The housing interior chamber is formed to receive at least one battery cell. Moreover, the housing cover has a protective layer at least regionally overlapping with the covering layer to withstand a thermal load, which is caused by a heat supply of the housing cover in the event of an emergency degassing of the at least one battery cell. The protective layer is mechanically connected to the covering layer in connection regions and, in protective regions, is arranged spaced apart from the covering layer by forming a gap provided to increase a thermal transition resistance between the protective layer and the covering layer.

Exemplary embodiments of the invention are directed to an improved housing part, in particular an improved housing cover, for a battery housing of a traction battery of a vehicle that can be operated electrically and which saves construction space and is cost-effective to produce.

Exemplary embodiments of the invention are also directed to a battery housing for a traction battery of a vehicle that can be operated electrically having such an improved housing part.

Exemplary embodiments of the invention are further directed to a traction battery for a vehicle that can be operated electrically having such a battery housing.

According to an aspect of the invention, a housing part, in particular housing cover, for a battery housing of a traction battery of a vehicle that can be operated electrically is proposed for connecting to a second housing part of the battery housing, with a construction made of several layers with different materials. The housing part comprises at least one outer layer made of a plastic, a metal layer, in particular made of steel, a structural layer made of a structural material, wherein the outer layer and the metal layer are connected over a large surface area. The structural layer covers at least one part of a surface of the outer layer and/or the metal layer. An intermediary layer is arranged between the structural layer and the combination of the outer layer and metal layer.

The proposed housing part, in particular housing cover, for a traction battery is made up of several layers with different properties.

The outer layer forms a corrosion protection layer for the housing part, and thermal insulation and stone chip protection for traction batteries in the underfloor region of a vehicle.

This outer layer is fixedly connected to the metal layer, which can be formed as a steel inlay. This metal layer can be over-molded with the material of the housing part, for example, in the production process of the housing part or poured into the material. The metal layer protects the inside of the traction battery from punctual loads in the vertical z-direction of the vehicle, since this can greatly deform and does not get chapped under load. Thus, a density of the housing part can be ensured. Similarly, the metal layer also forms a protection from the housing part burning through from a cell module in the event of a thermal event of a battery cell. Moreover, the metal layer forms electromagnetic shielding. Thus, additional metallic coverings for an improved electromagnetic compatibility (EMC) can be dispensed with, and construction space can be saved.

An intermediary layer is fitted onto the metal layer, the intermediary layer serving as a connection layer between the metal layer or the combination of the outer layer and metal layer and a structural layer lying above it and arranged spaced apart in the direction of the interior chamber of the housing part.

The structural layer is formed by a material with a higher elasticity modulus, for example made of steel and/or aluminum and/or fiber-reinforced plastic, and forms a so-called upper chord in the layer construction. Bending forces or torsion forces are conducted through the upper layer or lower layer. Here, a material with a high elasticity modulus can advantageously be used.

The strains on housing covers in a high-voltage battery are caused by oscillations in the driving operation of the vehicle, for example as a result of air currents generating negative pressure, or vibrations, caused by the road surface, but also when touching down on or driving over large objects, as well as the gas pressure that occurs in the high-voltage battery in the event of a thermal event. Extensive parts, such as housing covers in high-voltage batteries of vehicles, which can be set in vibration very easily, usually have to be braced using additional screwing points, which can be omitted with the housing part proposed.

With the layer construction of the housing part according to the invention, in particular the housing cover, oscillations and/or unpleasant sounds can be reduced or avoided entirely. Thus, strains on the materials are reduced.

The multi-layer construction makes it possible to brace a housing cover over a large surface without here having to additionally brace this surface. Here, the strains are absorbed across the formed upper chord layer. The strains in the so-called lower chord are transferred via the covering outer layer. An intermediary layer arranged between the outer layer with the metal layer and the structural layer can serve to distribute the load.

If the housing is subject to bending, for example as a result of oscillations, in the driving operation of the vehicle, or when placing on an object, or as a result of the gas pressure in a thermal event, the uppermost layer is subject to tensile force. Here, the highest forces emerge. In the lowermost layer, the lower chord, the same forces emerge, yet in a different direction from compression forces. An intermediary structure is hardly loaded or not loaded at all. Thus, an efficient upper chord and a lower chord, for example made of steel, ensure a high efficiency capability of the design.

The combination of several layers with different materials enables an improved inherent rigidity of extensive parts. Structural layers allow connection points to be dispensed with for extensive components, and an even load distribution with punctual force applications. For example, forces are distributed over a large area in a vertical z-direction of the component when installed in a vehicle as intended, such that only a reduced surface load acts on the inside of the battery. An integration of several requirements in the individual layers, such as forming gas channels and the presence of insulation properties, is advantageously possible.

According to an advantageous design of the housing part, the metal layer can be integrated into the outer layer. In particular, the metal layer can here be over-molded with the material of the outer layer or poured into the material of the outer layer. Thus, a fixed connection or incorporation of the metal layer into the outer layer is possible, which can be produced inexpensively using conventional plastic manufacturing methods.

According to an advantageous design of the housing part, the structural layer can be formed from a material with a higher elasticity modulus than an elasticity modulus of the combination of the outer layer and metal layer. In particular, the structural layer can here have at least steel and/or aluminum and/or fiber-reinforced plastic. In particular, the structural layer can be formed from steel and/or aluminum and/or fiber-reinforced plastic. Advantageously, bending forces or torsional forces can thus be conducted through the upper layer or lower layer of the multi-layer structure of the housing part.

Together with the steel inlay of the outer layer, a structural upper chord, and lower chord construction is thus depicted. Thus, the rigidity of the housing part can clearly be increased and the overall oscillations clearly reduced. It is thus possible to avoid possible support screw fittings and the laborious process steps associated with these.

According to an advantageous design of the housing part, the intermediary layer can have a molded foam. In particular, the intermediary layer can here have at least one of plastic foam, in particular polyurethane foam, hollow cores made of paper, glass fabrics, textiles.

The intermediary layer made of molded foam can be placed onto the steel inlay of the outer layer. The molded foam can advantageously be made of a material that distributes the force across a surface when loaded in the z-direction and reduces the punctual load on a cell module arranged inside the battery housing. The intermediary layer can be produced, for example, by foaming up or adhering to the outer layer with the steel inlay.

According to an advantageous design of the housing part, the intermediary layer can have channels for diverting fluids, in particular gases. For example, gases emerging in a thermal event can be correspondingly diverted via the channels.

According to an advantageous design, the housing part can further comprise an electrical insulation layer made of an electrically insulating material, in particular made of at least one of plastic, ceramic, fiber-plastic composite material. The insulation layer can advantageously be applied as an innermost layer of the battery housing and can be used as an electrical insulator to a cell module mounted above it.

According to an advantageous design of the housing part, the metal layer can be fixedly connected to the intermediary layer and/or the structural layer to the electrical insulation layer. In this way, a massive layer construction of the housing part is to be obtained, which has an advantageous level of housing rigidity in comparison to conventional battery housings.

According to an advantageous design of the housing part, at least one uniformly formed gas passage region can be arranged in the structural layer and the electrical insulation layer, in order to guide fluids, in particular gases, from a housing interior chamber in channels of the intermediary layer. Gases or particles emerging in the event of a thermal event can be guided via the gas passage region into the channels of the intermediary layer and via this dissipated out of the housing interior chamber.

According to a further aspect of the invention, a battery housing is proposed for a traction battery of a vehicle that can be operated electrically, having a first housing part, in particular a housing covering, and having a second housing part, wherein the first housing part has a construction made of several layers with different materials, at least comprising an outer layer made of a plastic, a metal layer with a steel inlay, a structural layer made of a structural material, wherein the outer layer and the metal layer are connected over a large area. The structural layer covers at least one part of a surface of the outer layer and/or the metal layer. An intermediary layer is arranged between the structural layer and the combination of outer layer and metal layer.

With the battery housing formed as described above with at least one first housing part, a part of the screw connections of a conventional battery housing can be omitted due to the increased rigidity as a result of the multi-layer construction with different materials. Thus, production and checking costs for the battery housing are reduced.

Furthermore, an improvement of disruptive oscillation behavior of extensive components, such as a housing cover or a housing trough, can be achieved. Moreover, a simpler disassembly in the event of necessary repairs is possible due to a reduced number of screws or fixings.

Advantageously, the battery housing has a functional integration; individual layers take on different tasks, such as, for example, increasing the rigidity, damping the oscillation behavior, forming gas channels. Thus, more construction space for battery cells can be created and thus more range obtained.

According to a further aspect of the invention, a traction battery for a vehicle that can be operated electrically is proposed, having a plurality of battery cells and such a battery housing, wherein the battery cells are arranged in a housing interior chamber of the battery housing.

Advantageously, the traction battery with such a battery housing as described above can provide a larger free inner volume for accommodating battery cells with the same outer volume. Thus, a greater energy content of the traction battery emerges, which leads to a greater range of the vehicle equipped with it.

Further advantages emerge from the following description of the drawings. In the drawings, an exemplary embodiment of the invention is depicted. The drawings, the description and the claims contain numerous features in combination. The person skilled in the art will also expediently consider the features individually and combine them into useful further combinations.

### BRIEF DESCRIPTION OF THE DRAWING FIGURES

Here are shown:

FIG. 1 a cross-section through a part of a housing part, in particular housing cover, for a battery housing of a traction battery of a vehicle that can be operated electrically according to an exemplary embodiment of the invention;

FIG. 2 an isometric depiction of a cut-out of the housing part according to FIG. 1 with unfolded intermediary layer according to an exemplary embodiment of the invention; and

FIG. 3 an isometric depiction of a cut-out of the housing part according to FIG. 1 with unfolded intermediary layer according to a further exemplary embodiment of the invention.

In the figures, the same and similar components are numbered with the same reference numerals. The figures only show examples and are not to be understood as limiting.

### DETAILED DESCRIPTION

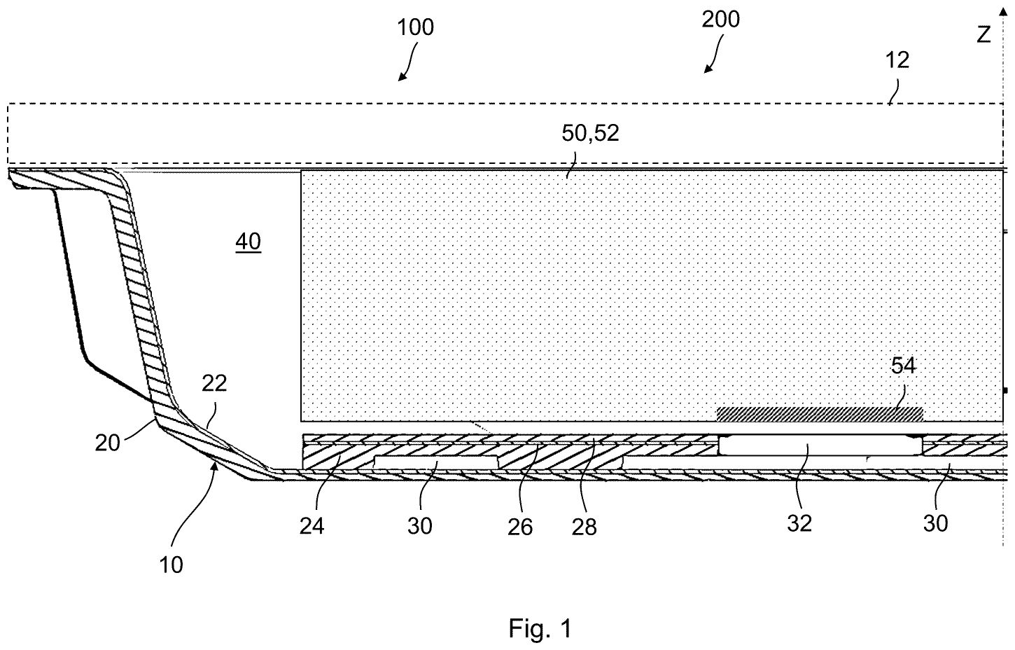

FIG. 1 shows a cross-section through a part of a housing part 10, in particular housing cover 10, for a battery housing 100 of a traction battery 200 of a vehicle that can be operated electrically according to an exemplary embodiment of the invention.

The housing cover 10 is depicted partially cut off in cross-section in order to show an enlarged depiction of the construction. A second housing part 12 of the battery housing 100, which is connected to the housing cover 10, is only depicted schematically as a plate. At least one battery module 52 is depicted in the housing interior chamber 40, the battery module comprising further battery cells 50, not depicted, of the traction battery 200.

The housing cover 10 has a construction made of several layers 20, 22, 24, 26 with different materials and comprises an outer layer 20 made of a plastic, a metal layer 22 made of steel, and a structural layer 26 made of a structural material. The outer layer 20 and the metal layer 22 are connected over a large surface area.

In the exemplary embodiment depicted in FIG. 1, the metal layer 22 rests on the outer layer 20 and is fixedly connected to this. Alternatively, the metal layer 22 can be integrated into the outer layer 20. In particular, the metal layer 22 can be over-molded with the material of the outer layer 20 or poured into the material of the outer layer 20, in order to form a solid compound. Thus, a fixed connection or incorporation of the metal layer 22 into the outer layer 20 is possible, which can be produced inexpensively using conventional plastic manufacturing methods.

The structural layer 26 covers at least one part of a surface of the outer layer 20 and/or the metal layer 22. Here, an intermediary layer 24 is arranged between the structural layer 26 and the combination of the outer layer 20 and the metal layer 22.

The structural layer 26 is preferably formed from a material with a high elasticity modulus as an elasticity modulus of the combination of the outer layer 20 and metal layer 22. In particular, the structural layer 26 can have at least steel and/or aluminum and/or fiber-reinforced plastic or be formed from steel and/or aluminum and/or fiber-reinforced plastic. Advantageously, bending forces or torsional forces can thus be conducted through the upper layer or lower layer of the multi-layer structure of the housing part 10.

The intermediary layer 24 can preferably have a molded foam. In particular, the intermediary layer 24 can have plastic foam, for example polyurethane foam. Alternatively, or additionally, it is also possible that the intermediary layer 24 has hollow cores made of paper, and/or glass fabrics, and/or textiles.

The molded foam can advantageously be made of a material that distributes the force across a surface when loaded in the z-direction and reduces the punctual load on a cell module 52 arranged inside the battery housing 100. The intermediary layer 24 can be produced, for example, by foaming up or adhering to the outer layer with the steel inlay.

On the side of the structural layer 26 directed towards the housing interior chamber 40, the housing part 10 comprises an electrical insulation layer 28 made of an electrically insulating material. In particular, the electrical insulation layer 28 can be formed, for example, from plastic, ceramic, or a fiber-reinforced compound material. The structural layer 26 is here fixedly connected to the electrical insulation layer 28. The insulation layer 28 can advantageously be applied as the innermost layer of the battery housing 100 and, for reasons of safety, can be used as an electrical insulator from a cell module 52 mounted above it.

As can be seen further in FIG. 1, the intermediary layer 24 can have channels 30 for diverting fluids, in particular gases. Fluids, in particular gases, emerging in a thermal event, for example, can be correspondingly diverted via the channels 30.

Furthermore, a uniformly formed gas passage region 32 is arranged in the structural layer 26 and the electrical insulation layer 28 in order to guide the fluids, in particular gases, from the housing interior chamber 40 into the channels 30 of the intermediary layer 24. Here, an opening region 54 of the battery cells 50 is schematically depicted in the battery module 52, from which opening region fluids, in particular gases, can flow via the gas passage region 32 into the channels 30.

The combination of several layers 20, 22, 24, 26 with different materials enables an improved inherent rigidity of the housing cover 10. Such a multi-layer construction makes it possible to omit connection points for the housing cover 10, and to evenly distribute the load with punctual force applications. For example, forces are distributed over a large area in a vertical z-direction of the component 10 when installed in a vehicle as intended, such that only a reduced surface load acts on the inside of the battery 200. An integration of several requirements in the individual layers 20, 22, 24, 26, such as forming gas channels 30 and the presence of insulation properties, is advantageously possible.

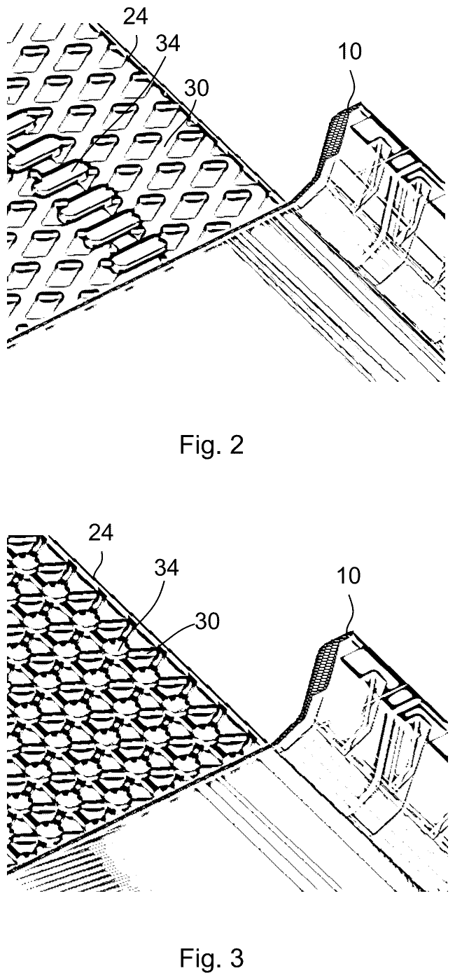

FIG. 2 shows an isometric depiction of a cut-out of the housing part 10 according to FIG. 1 with an unfolded intermediary layer 24 according to an exemplary embodiment of the invention.

Here, the housing part 10 is depicted cut-off, such that only the intermediary layer 24 can still be recognized in a part of the housing part 10. The intermediary layer 24 is formed from molded foam and is depicted in a design for prismatic battery cells. This can be seen at the elliptical degassing openings 34 arranged in a row, which are arranged in the central region of the intermediary layer 24. Fluid, in particular gases emerge from venting openings of the battery cells via the degassing openings 34 of the intermediary layer 24. In the intermediary layer 24, the fluids can then be diverted from the degassing openings 34 via the channels 30. For reasons of clarity, in each case only individual degassing openings 34 and channels 30 are provided with reference numerals.

FIG. 3 shows an isometric depiction of a cut-out from the housing part according to FIG. 1 with an unfolded intermediary layer according to a further exemplary embodiment of the invention.

This design of the intermediary layer 24 is provided for round cells. The degassing openings 34 in the intermediary layer 24 are formed in a circle and are arranged in a tightest packing for cylindrical round cells, which are arranged to stand one next to the other. The channels 30 for diverting the fluids connect the different degassing openings 34.

### LIST OF REFERENCE NUMBERS

10 Housing part
12 Second housing part
20 Outer layer
22 Metal layer
24 Connection layer
26 Structural layer
28 Electrical insulation layer
30 Channel
32 Gas passage region
34 Degassing opening
40 Housing interior chamber
50 Battery cells
52 Battery module
54 Opening region
100 Battery housing
200 Traction battery

1-10. (canceled)

11. A housing part for a battery housing of a traction battery of an electrically operated vehicle, wherein the housing part is a housing cover comprising:
an outer layer made of a plastic;
a metal layer;
a structural layer made of a structural material having a higher elasticity modulus than an elasticity modulus of a combination of the outer layer and the metal layer; and
an intermediary layer arranged between the structural layer and the combination of the outer layer and the metal layer,
wherein the outer layer and the metal layer are connected over a large area,
wherein the structural layer covers at least one part of a surface of the outer layer or the metal layer,
wherein the structural layer forms an upper chord in a layer construction of the outer layer, metal layer, structural layer, and intermediary layer, and
wherein the housing cover is configured to connect to a second housing part of the battery housing.

12. The housing part of claim 11, wherein the metal layer is integrated into the outer layer.

13. The housing part of claim 12, wherein the metal layer is over-molded with material of the outer layer or is poured into the material of the outer layer.

14. The housing part of claim 11, wherein the structural material of the structural layer is comprised of at least steel, aluminum, or fiber-reinforced plastic.

15. The housing part of claim 11, wherein the intermediary layer comprises a molded foam

16. The housing part of claim 15, wherein the molded foam is a polyurethane foam or is comprised of hollow cores made of paper, glass fabrics, or textiles.

17. The housing part of claim 14, wherein the intermediary layer has channels configured to divert fluids.

18. The housing part of claim 11, further comprising:
an electrical insulation layer made of an electrically insulating material.

19. The housing part of claim 18, wherein the electrically insulating material is at least one of plastic, ceramic, and fiber-plastic composite material.

20. The housing part of claim 18, wherein
the metal layer is fixedly connected to the intermediary layer, or
the structural layer is fixedly connected to the electrical insulation layer.

21. The housing part of claim 17, wherein at least one uniformly formed gas passage region is arranged in the structural layer and the electrical insulation layer, wherein the at least one uniformly formed gas passage region is configured to guide the fluids from a housing interior chamber into the channels of the intermediary layer.

22. A battery housing for a traction battery of an electrically operated vehicle, the battery housing comprising:
a housing interior chamber configured so that a plurality of battery cells are arrangeable in the housing interior chamber;
a first housing part, which is housing cover; and
a second housing part configured to connect to the first housing part,
wherein the first housing part comprises
an outer layer made of a plastic;
a metal layer;
a structural layer made of a structural material having a higher elasticity modulus than an elasticity modulus of a combination of the outer layer and the metal layer; and
an intermediary layer arranged between the structural layer and the combination of the outer layer and the metal layer,
wherein the outer layer and the metal layer are connected over a large area,
wherein the structural layer covers at least one part of a surface of the outer layer or the metal layer, and
wherein the structural layer forms an upper chord in a layer construction of the outer layer, metal layer, structural layer, and intermediary layer.

23. A traction battery for an electrically operated vehicle, the traction battery comprising:
a plurality of battery cells; and
a battery housing comprising
a housing interior chamber in which the plurality of battery cells are arranged;
a first housing part, which is housing cover; and
a second housing part configured to connect to the first housing part,
wherein the first housing part comprises
an outer layer made of a plastic;
a metal layer;
a structural layer made of a structural material having a higher elasticity modulus than an elasticity modulus of a combination of the outer layer and the metal layer; and
an intermediary layer arranged between the structural layer and the combination of the outer layer and the metal layer,
wherein the outer layer and the metal layer are connected over a large area,
wherein the structural layer covers at least one part of a surface of the outer layer or the metal layer, and
wherein the structural layer forms an upper chord in a layer construction of the outer layer, metal layer, structural layer, and intermediary layer.
